(19) United States
(12) Patent Application Publication
(10) Pub. No.: US 2025/0191216 A1
(43) Pub. Date: Jun. 12, 2025

(54) BLUR OBJECT DETECTION SYSTEM AND BLUR OBJECT DETECTION METHOD

(71) Applicant: Industrial Technology Research Institute, Hsinchu (TW)

(72) Inventors: Po-Wei Chen, Hsinchu County (TW); Yu-Han Kao, Hsinchu County (TW); Yu-Ling Liu, Taoyuan City (TW)

(73) Assignee: Industrial Technology Research Institute, Hsinchu (TW)

(21) Appl. No.: 18/544,451

(22) Filed: Dec. 19, 2023

(30) Foreign Application Priority Data
Dec. 8, 2023 (TW) 112147842

(51) Int. Cl. G06T 7/73

(52) U.S. Cl. CPC G06T 7/73; G06T 2207/20084

(57) ABSTRACT

A blur object detection system includes a memory, an image capturing device, and a processor. The image capturing device is configured to capture a dynamic image, in which the dynamic image includes a blur object and a general object. The processor is coupled to the image capturing device and the memory, and configured to simultaneously or non-simultaneously perform image compression, blur object detection, and general object detection based on the dynamic image to obtain an image compression file, a blur object position of the blur object in the dynamic image, and a general object position of the general object in the dynamic image, and store the image compression file, the blur object position, and the general object position to the memory.

### CROSS-REFERENCE TO RELATED APPLICATION

This application claims the priority benefit of Taiwan application serial no. 112147842, filed on Dec. 8, 2023. The entirety of the above-mentioned patent application is hereby incorporated by reference herein and made a part of this specification.

### TECHNICAL FIELD

The disclosure relates to an object detection technology, and in particular relates to a blur object detection system and a blur object detection method.

### BACKGROUND

In order to ensure the safety of flying or traveling of drones or unmanned vehicles, it is important to accurately detect the positions of dynamic objects. The traditional method of identifying a blur object requires recovering a blur image first and then performing object identification. Specifically, after a dynamic object is captured into the blur image by a camera, the blur image must first be recovered (e.g., HDR). Next, image processing such as white balance, autofocus, background removal, etc., is performed. Then, general object detection is performed to obtain the object position. The disadvantage of the traditional approach is that it is time-consuming, and further consumes computing resources to recover the blur object. Therefore, how to identify the blur object in the image without first recovering the blur object, save time, and reduce terminal resource requirements, are problems that the field intends to solve.

### SUMMARY

The disclosure provides a blur object detection system, which includes a memory, an image capturing device, and a processor. The image capturing device is configured to capture a dynamic image, in which the dynamic image includes a blur object and a general object. The processor is coupled to the image capturing device and the memory, and configured to simultaneously or non-simultaneously perform image compression, blur object detection, and general object detection based on the dynamic image to obtain an image compression file, a blur object position of the blur object in the dynamic image, and a general object position of the general object in the dynamic image, and store the image compression file, the blur object position, and the general object position to the memory.

In an embodiment, the processor is further configured to read the image compression file from the memory, decompress the image compression file into an image stream, and recover the blur object in the image stream based on the blur object position.

In an embodiment, the processor is further configured to determine that the blur object is a physical object based on an object feature of the blur object, and recover the blur object in the image stream based on the blur object position.

In an embodiment, the processor is further configured to select the recovered blur object in the image stream based on the blur object position

In an embodiment, the processor is further configured to perform blur object detection and general object detection on the dynamic image through an optical flow method.

In an embodiment, the optical flow method further includes an image calibration method, a clustering algorithm, and a motion compensation method.

The disclosure provides a blur object detection method, which includes the following steps. A dynamic image is captured by an image capturing device, in which the dynamic image includes a blur object and a general object. Image compression, blur object detection, and general object detection are simultaneously or non-simultaneously performed based on the dynamic image by the processor to obtain an image compression file, a blur object position of the blur object in the dynamic image, and a general object position of the general object in the dynamic image. The image compression file, the blur object position, and the general object position are stored to the memory by the processor.

Based on the above, the blur object detection system and the blur object detection method of the disclosure can identify the blur object without the need for the object in the image to be clear. Even if only partial recovery of the blur object is required when identifying the blur object in the image, the consumption of computing resources can be reduced.

### BRIEF DESCRIPTION OF THE DRAWINGS

FIG. 1 is a structural diagram of a blur object detection system according to an embodiment of the disclosure.

FIG. 2 is a flowchart of a blur object detection method according to an embodiment of the disclosure.

FIG. 3 is a schematic diagram of a dynamic image according to an embodiment of the disclosure.

FIG. 4 is a schematic diagram of object position detection through an artificial neural network according to an embodiment of the disclosure.

FIG. 5 is a schematic diagram of recovering a blur object through an artificial neural network according to an embodiment of the disclosure.

FIG. 6 is a schematic diagram of object position detection through an optical flow method according to an embodiment of the disclosure.

FIG. 7 is a schematic diagram of an optical flow method according to an embodiment of the disclosure.

### DETAILED DESCRIPTION OF DISCLOSED EMBODIMENTS

Some embodiments of the disclosure accompanied with drawings are described in detail as follows. The reference numerals used in the following description are regarded as the same or similar elements when the same reference numerals appear in different drawings. These embodiments are only a part of the disclosure, and do not disclose all the possible implementation modes of the disclosure.

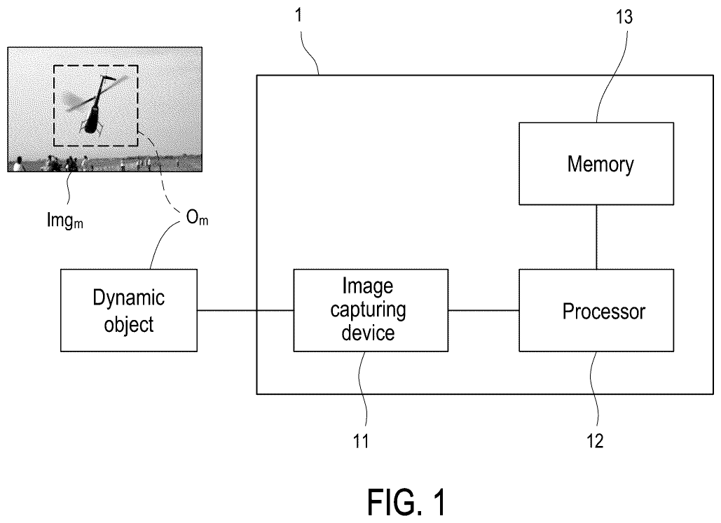

FIG. 1 is a structural diagram of a blur object detection system 1 according to an embodiment of the disclosure. Referring to FIG. 1, the blur object detection system 1 includes an image capturing device 11, a processor 12, and a memory 13. Practically speaking, the blur object detection system 1 can be implemented by computer devices with computing functions, display functions, and networking functions such as desktop computers, notebook computers, tablet computers, and workstations, and the disclosure is not limited thereto.

The image capturing device 11 is configured to capture a dynamic image Imgₘ of a dynamic object Oₘ for the dynamic object Oₘ. Practically speaking, the image capturing device 11 can be a device with an image capturing function built into a computer device implementing the blur object detection system 1, or can be a device with an image capturing function of a computer device implementing the blur object detection system 1 such as a wired or wireless connected camera and a video recorder, and the disclosure is not limited thereto.

The processor 12 is coupled to the image capturing device 11 and the memory 13. Practically speaking, the processor 12 can be a central processing unit (CPU), a micro-processor, or an embedded controller built into the computer device implementing the blur object detection system 1, and the disclosure is not limited thereto.

Practically speaking, the memory 13 is, for example, a static random-access memory (SRAM), a dynamic random access memory (DRAM), or other memory, and the disclosure is not limited thereto.

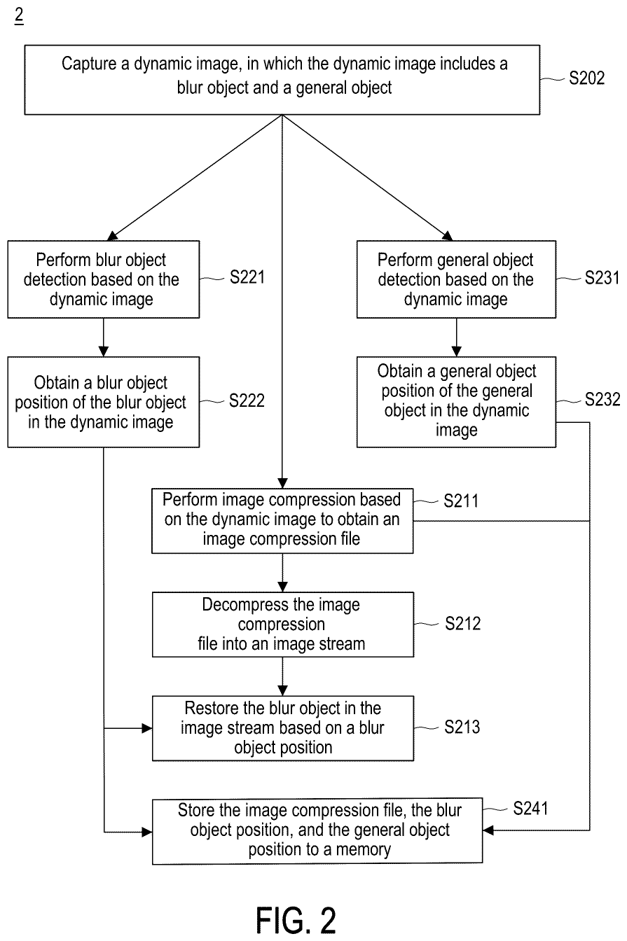

The image capturing device 11, the processor 12, and the memory 13 included in the blur object detection system 1 cooperate together to execute a blur object detection method 2. FIG. 2 is a flowchart of a blur object detection method 2 according to an embodiment of the disclosure. The blur object detection method 2 of FIG. 2 can capture the dynamic image Imgₘ through the image capturing device 11 of the blur object detection system 1 of FIG. 1, and then perform subsequent processes on the dynamic image Imgₘ through the processor 12. The blur object detection method 2 includes steps S202, S211-S213, S221-S222, S231-S232, and S241. Next, please refer to FIG. 1 and FIG. 2 at the same time, and the blur object detection method 2 will be explained.

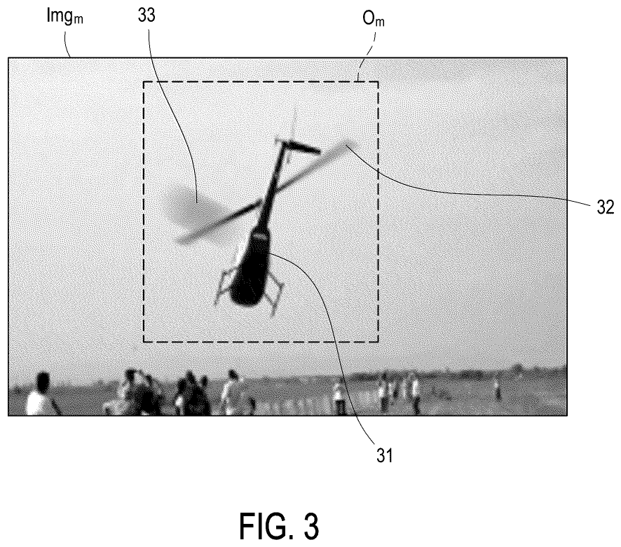

First, in step S202, the dynamic image Imgₘ of the dynamic object Oₘ is captured for the dynamic object Oₘ by the image capturing device 11, in which the dynamic image Imgₘ includes a blur object and a general object. It should be noted that when the image capturing device 11 captures the dynamic image Imgₘ of the dynamic object Oₘ for the dynamic object Oₘ, the dynamic object Oₘ must exist in a capturing range. However, there may also be other objects in the capturing range that enter the capturing range when the image capturing device 11 captures the dynamic image Imgₘ. The other objects may be static objects or may be in motion. Therefore, the blur object included in the dynamic image Imgₘ may be part of the dynamic object Oₘ and/or other dynamic objects. Next, the blur object and the general object included in the dynamic image Imgₘ will be further explained through FIG. 3.

FIG. 3 is a schematic diagram of a dynamic image Imgₘ according to an embodiment of the disclosure. Referring to FIG. 3, for example, the dynamic object Oₘ in the dynamic image Imgₘ shown in FIG. 3 is mainly an identifiable drone. A fuselage 31 of the drone presents a clear status image in the dynamic image Imgₘ. Therefore, the fuselage 31 of the drone is classified as the general object in the dynamic image Imgₘ. A propeller 32 of the drone is blurred due to rapid rotation. Therefore, the propeller 32 of the drone is classified as the blur object in the dynamic image Imgₘ. In addition, there are other objects 33 other than the drone next to the propeller 32 of the drone, which fly quickly past and are blurry when the image capturing device 11 captures the dynamic image Imgₘ of the dynamic object Oₘ. Therefore, the other objects 33 other than the drone are also classified as the blur objects in the dynamic image Imgₘ.

Referring to FIG. 1 and FIG. 2 again, after the image capturing device 11 captures the dynamic image Imgₘ of the dynamic object Oₘ for the dynamic object Oₘ, the processor 12 will simultaneously or non-simultaneously perform image processing such as image compression, blur object detection, and general object detection based on the dynamic image Imgₘ to obtain an image compression file, a blur object position of the blur object in the dynamic image Imgₘ, and a general object position of the general object in the dynamic image Imgₘ.

In an embodiment, the processor 12 can simultaneously perform image processing such as image compression, blur object detection, and general object detection based on the dynamic image Imgₘ to obtain the image compression file, the blur object position of the blur object in the dynamic image Imgₘ, and the general object position of the general object in the dynamic image Imgₘ. As shown in FIG. 2, the processor 12 performs image compression based on the dynamic image in step S211 to obtain the image compression file. Simultaneously, after performing blur object detection based on the dynamic image in step S221, the processor 12 obtains the blur object position of the blur object in the dynamic image in step S222. Simultaneously, after performing general object detection based on the dynamic image in step S231, the processor 12 obtains the general object position of the general object in the dynamic image in step S232.

In another embodiment, the processor 12 can, using time-division multiplexing, perform image processing, such as image compression, blur object detection, and general object detection based on the dynamic image Imgₘ to obtain the image compression file, the blur object position of the blur object in the dynamic image Imgₘ, and the general object position of the general object in the dynamic image Imgₘ. That is, the processor 12 can perform step S211, step S221, and step S231 using time-division multiplexing.

Once obtaining the image compression file in step S211, the blur object position in step S222, and the general object position in step S232, the processor 12 stores the image compression file, the blur object position, and the general object position to the memory 13 in step S241. The image compression file corresponding to the dynamic image Imgₘ can be further used as other applications.

In the blur object detection system 1 and the blur object detection method 2 of the disclosure, the processor 12 reads the image compression file corresponding to the dynamic image Imgₘ from the memory 13, decompresses the image compression file into an image stream, and recovers the blur object in the image stream based on the blur object position. In step S212, the processor 12 decompresses the image compression file into an image stream. Once obtaining the blur object position of the blur object in the dynamic image in step S222, the processor 12 recovers the blur object in the image stream based on the blur object position in step S213.

In an embodiment, as shown in FIG. 3, compared with the general object (such as the fuselage 31 of the drone), if the blur objects (such as the propeller 32 and the other objects 33 of the drone) result in blur images in the dynamic image Imgₘ due to conditions such as rapid movement, shaking, poor focus, or poor lighting, the processor 12 is further configured to perform object position detection through an artificial neural network.

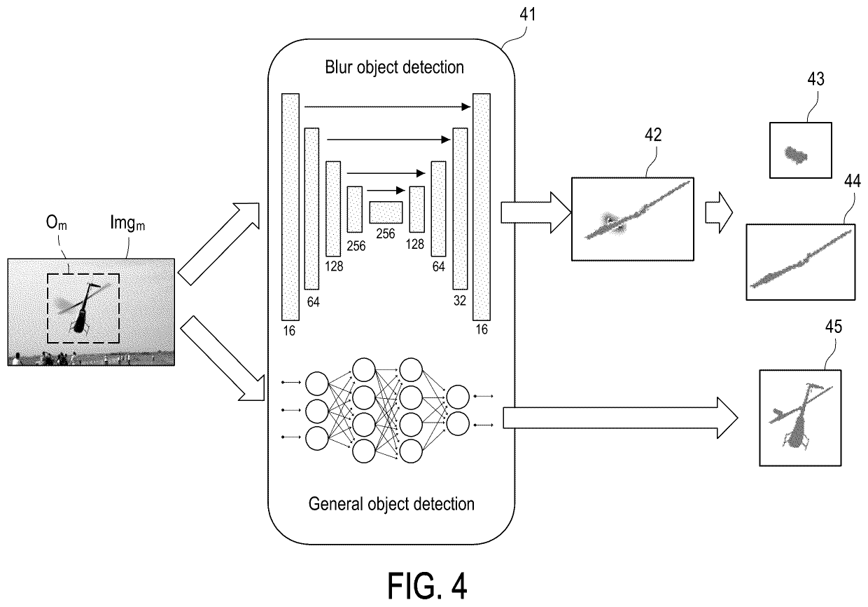

FIG. 4 is a schematic diagram of object position detection through an artificial neural network 41 according to an embodiment of the disclosure. Referring to FIG. 4, the processor 12 performs blur object detection and general object detection on the dynamic image Imgₘ through the artificial neural network 41 to obtain the blur object position of the blur object in the dynamic image Imgₘ and the general object position of the general object in the dynamic image Imgₘ.

Specifically, when performing blur object detection on the dynamic image Imgₘ through the artificial neural network 41, the processor 12 will first detect all blur objects 42 and obtain the blur object positions of a blur object 43, a blur object 44, etc., in the dynamic image Imgₘ respectively. When performing general object detection on the dynamic image Imgₘ through the artificial neural network 41, the processor 12 will first detect all clear general objects 45 and obtain the blur object positions in the dynamic image Imgₘ.

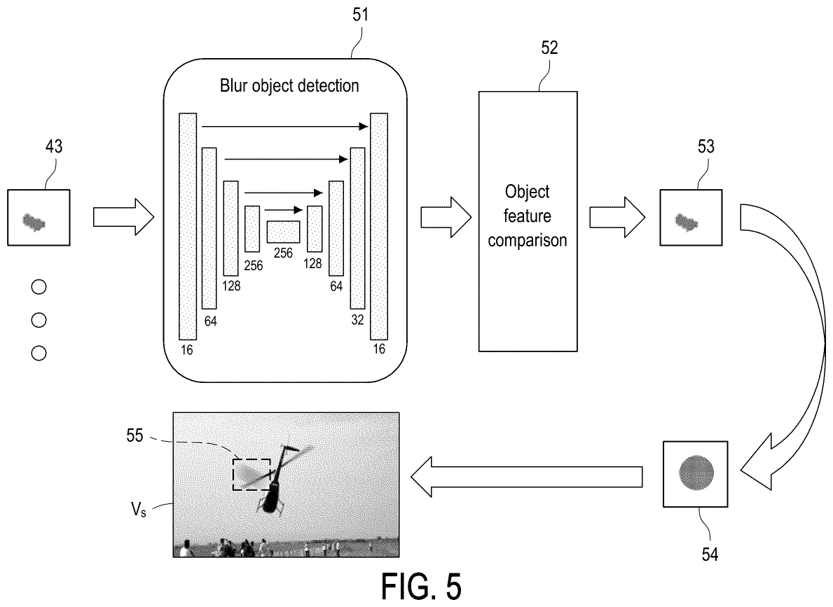

FIG. 5 is a schematic diagram of recovering the blur object 43 through an artificial neural network 51 according to an embodiment of the disclosure. Referring to FIG. 5, the processor 12 performs blur object detection on the blur object 43 through the artificial neural network 51 and determines whether the blur object 43 is a physical object based on an object feature comparison 52 of the blur object 43. Specifically, the object feature comparison 52 of the blur object 43 includes: comparing the edges of a plurality of identical blur objects 43 in the dynamic image, comparing the trajectories of a plurality of identical blur objects 43 in the dynamic image, etc. Once the processor 12 determines that the blur object 43 is a physical object 53, the blur object is recovered in the image stream based on the blur object position, as shown by a recovered blur object 54 in FIG. 5. In an embodiment, the processor 12 is further configured to select 55 the recovered blur object 54 in an image stream Vs based on the blur object position.

In an embodiment, if the blur objects (such as the propeller 32 and the other objects 33 of the drone as shown in FIG. 3) result in blur images in the dynamic image Imgₘ due to conditions such as rapid movement, shaking, poor focus, or poor lighting, the processor 12 is also configured to perform object position detection through an optical flow method.

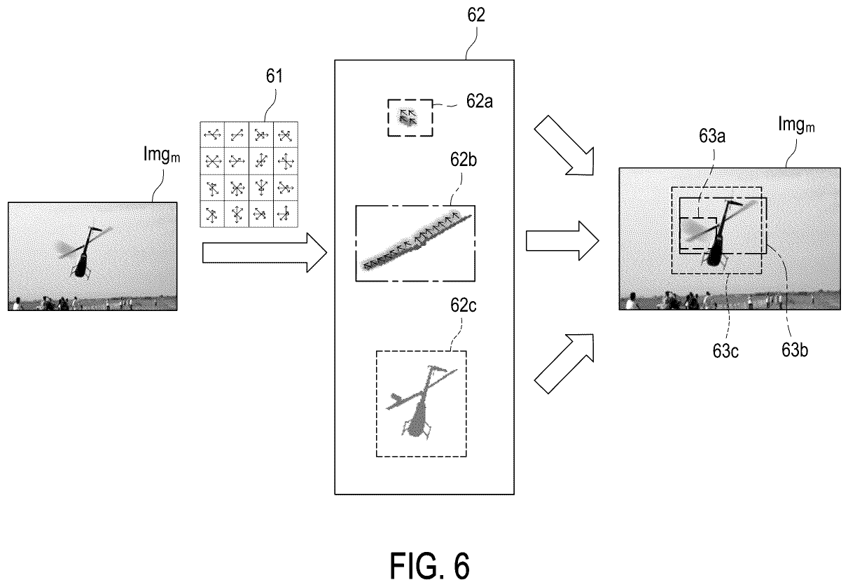

FIG. 6 is a schematic diagram of object position detection through an optical flow method 62 according to an embodiment of the disclosure. Referring to FIG. 6, the processor 12 performs blur object detection 62a and 62b and general object detection 62c on the dynamic image Imgₘ based on a feature vector 61 through the optical flow method 62 to obtain blur object positions 63a and 63b of the blur objects in the dynamic image Imgₘ and a general object position 63c of the general object in the dynamic image Imgₘ.

In order to improve optical flow quality, reduce probability of misjudgment of an object caused by optical flow noise, and improve accuracy of determining whether the blur object is a real object, the optical flow method 62 also includes an image calibration method, a clustering algorithm, and a motion compensation method.

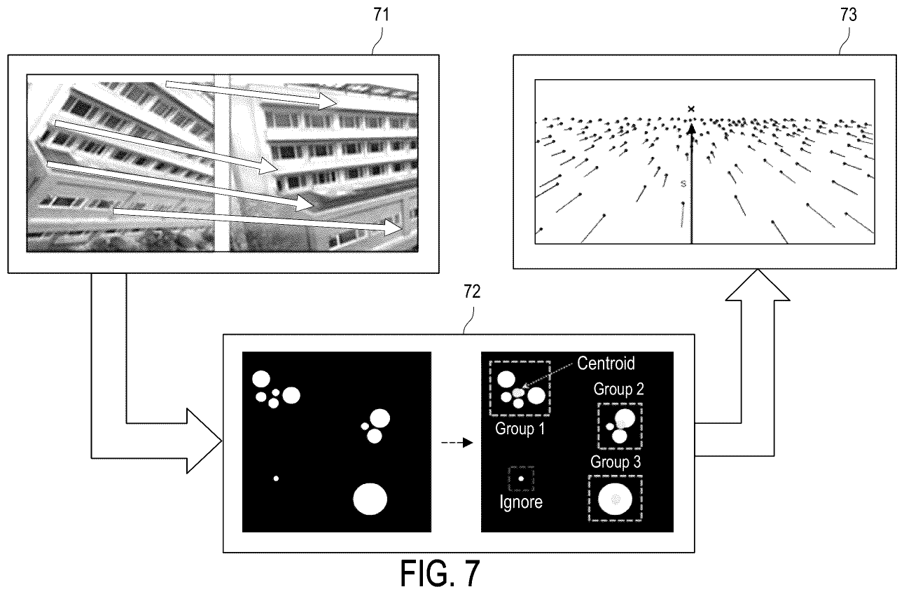

FIG. 7 is a schematic diagram of the optical flow method 62 according to an embodiment of the disclosure. Referring to FIG. 6 and FIG. 7, when the processor 12 performs blur object detection and general object detection on the dynamic image Imgₘ through the optical flow method 62, the processor 12 will execute an image calibration method 71 to process the feature points of two consecutive pictures to improve optical flow quality, then execute a clustering algorithm 72 to reduce probability of misjudgment of optical flow noise, and finally execute a motion compensation method 73 to improve accuracy of determining whether the blur object is a real object. The image calibration method 71, the clustering algorithm 72, and the motion compensation method 73 mentioned here all enable the processor 12 to improve accuracy of detection when performing blur object detection 62a and 62b and general object detection 62c on the dynamic image Imgₘ through the optical flow method 62. As long as the method can improve optical flow quality, reduce probability of misjudgment of an object caused by optical flow noise, and improve accuracy of determining whether the blur object is a real object, it is within the scope of protection of the disclosure.

Based on the above, the blur object detection system and the blur object detection method of the disclosure can identify the blur object without the need for the object in the image to be clear. Even if only partial recovery of the blur object is required when identifying the blur object in the image, the consumption of computing resources can be reduced.

What is claimed is:

1. A blur object detection system, comprising:
a memory;
an image capturing device, configured to capture a dynamic image, wherein the dynamic image comprises a blur object and a general object; and
a processor, coupled to the image capturing device and the memory, and configured to simultaneously or non-simultaneously perform image compression, blur object detection, and general object detection based on the dynamic image to obtain an image compression file, a blur object position of the blur object in the dynamic image, and a general object position of the general object in the dynamic image, and store the image compression file, the blur object position, and the general object position to the memory.

2. The blur object detection system according to claim 1, wherein the processor is further configured to read the image compression file from the memory, decompress the image compression file into an image stream, and recover the blur object in the image stream based on the blur object position.

3. The blur object detection system according to claim 2, wherein the processor is further configured to determine that the blur object is a physical object based on an object feature of the blur object, and recover the blur object in the image stream based on the blur object position.

4. The blur object detection system according to claim 2, wherein the processor is further configured to select the recovered blur object in the image stream based on the blur object position.

5. The blur object detection system according to claim 2, wherein the processor is further configured to perform blur object detection and general object detection on the dynamic image through an optical flow method.

6. The blur object detection system according to claim 5, wherein the optical flow method further comprises an image calibration method, a clustering algorithm, and a motion compensation method.

7. A blur object detection method, comprising:
capturing a dynamic image by an image capturing device, wherein the dynamic image comprises a blur object and a general object;
simultaneously or non-simultaneously performing image compression, blur object detection, and general object detection based on the dynamic image by a processor to obtain an image compression file, a blur object position of the blur object in the dynamic image, and a general object position of the general object in the dynamic image; and
storing the image compression file, the blur object position, and the general object position to a memory by the processor.

8. The blur object detection method according to claim 7, further comprising:
reading the image compression file from the memory, decompressing the image compression file into an image stream, and recovering the blur object in the image stream based on the blur object position by the processor.

9. The blur object detection method according to claim 8, further comprising:
determining that the blur object is a physical object based on an object feature of the blur object, and recovering the blur object in the image stream based on the blur object position by the processor.

10. The blur object detection method according to claim 9, further comprising:
selecting the recovered blur object in the image stream based on the blur object position by the processor.

11. The blur object detection method according to claim 8, further comprising:
performing blur object detection and general object detection on the dynamic image through an optical flow method by the processor.

12. The blur object detection method according to claim 11, wherein the optical flow method further comprises an image calibration method, a clustering algorithm, and a motion compensation method.
